(19) United States
(12) Patent Application Publication
(10) Pub. No.: US 2008/0184963 A1
(43) Pub. Date: Aug. 7, 2008

(54) Connecting rod free piston machine

(75) Inventors: Viktor Alexandrovich Bezryadin, Rostov-Na-Donu (RU); Sergey Mikhaylovich Krasnikov, Rostov-Na-Donu (RU)

Correspondence Address: COLLARD & ROE, P.C., 1077 NORTHERN BOULEVARD, ROSLYN, NY, 11576, US

(73) Assignees: Konstantin Mikhaylovich AVERIN (25%); Yuriy Yuryevich SOLODUNOV (25%)

(21) Appl. No.: 12/082,169

(22) Filed: Apr. 9, 2008

Related U.S. Application Data
(63) Continuation of application No. PCT/RU2006/000533, filed on Oct. 16, 2006.

(30) Foreign Application Priority Data
Oct. 31, 2005 (RU) 2005133533

(51) Int. Cl. F02B 71/00

(52) U.S. Cl. 123/46 R

(57) ABSTRACT

The invention relates to mechanical engineering, namely to connecting rod free piston machines and solves a problem of making a safe and long-lived piston machine with compact dimensions. The machine includes a body with cover plates, an output shaft (which is installed on these cover plates and interacts with gears), as well as cylinders and pistons, disposed in pairs oppositely. Pistons are provided with support washers and axial bearings, produced with necks having spherical surfaces. These surfaces interact with slots of end ring, which is located between the support washers and necks of axial bearings. Axial bearings contact with roller-pushers located in hubs of gears, which are placed in stocks of output shaft and interact with fixed cog-wheel. At the same time the body is produced in the form of a ring and a transmission ratio of gears and cog-wheel is equal to 1:2.

### FIELD OF THE INVENTION

The invention relates to mechanical engineering, namely to connecting rod free piston machines, and can be used as an internal combustion engine and as a piston compressor or a pump in various spheres of national economy, for example, in transport.

### BACKGROUND OF THE INVENTION

Known in the art are connecting rod free piston internal-combustion engines (see a book of S. S. Balandin “Connecting rod free piston internal-combustion engines”, Mashinostroenie, Moscow, 1968, page 25, FIG. 23, page 39, FIG. 40, page 47, FIG. 48) with cross-shaped, X-shaped and Y-shaped arrangement of cylinders, containing a crank case, cylinders, pistons with rods, slide blocks or substituting them gears, crankshafts and etc.

The presence of slide blocks leads to decreasing of engine dimensions, but complicates the construction.

Known in the art is the connecting rod free piston internal-combustion engine (see Invention Certificate No 1262074, USSR C1. F04B 75/24, 7 Oct. 1986) including two pistons inflexibly connected to each other by a rod and located in a cylinder with the possibility of back-and-forth motion, two crankshafts, the necks of which are connected with rod with the help of bearings, two rods connecting the crankshafts, the cranks tied with the conjunctive shaft by means of gears, two mechanisms of gas distribution.

Such connecting rod free internal-combustion engine is complicate in construction, and the presence of crankshafts increases its length dimensions.

The most similar to the proposed connecting rod free piston internal-combustion engine which is a piston machine (see patent RU2006627, C1. F02B 75/32, 30 Jan. 1994) is known. This engine includes a body with side covers, in which on two sides are performed the supports of crank gears, the output shaft with at least a one gear fixed on it, cylinders with installed in them kinematically connected with the crank gears by means of the pins pistons with stocks interacting with additional coupling links, which are situated transversely to axle of appropriate cylinders and hingedly connected by means of the pins with two interconnected gears. Moreover the coupling links are performed on one side with the cylindrical lugs the axle of which is perpendicular to the axle of the coupling link, and on another side with the pivotal holes. The coupling links are interconnected by means of lugs and holes.

The disadvantage of this machine is in the presence in it of pistons with stocks interacting with coupling links, since by a power-stroke of the piston under the influence of power of rod in the middle of the coupling link appears a great bending moment, as well as a considerable frictional force commensurate to work force of the piston. This frictional force is acting in the places of connection of a piston rod with the coupling link. That leads to damages in the connection “piston rod-coupling link”, and as a result to decreasing of safety and service life of the machine.

### SUMMARY OF THE INVENTION

The technical task set in the proposed invention consists in the creation of such piston machine that would be safe and long-lived in working while having compact radial and longitudinal dimensions.

The problem put by is solved such a way: in a connecting rod free piston machine, comprising a body with covers, installed in them an output shaft interacting with gears, and also cylinders with pistons disposed in pairs oppositely, the pistons are provided with support washers and axial bearings performed with necks having spherical surfaces interacting with radial internal profile of slots performed in the end ring, which is situated between the support washers and the necks of axial bearings contacting with roller-pushers which are located in the hubs of the gears installed in the stocks of the output shaft and interacting with a fixed cog-wheel. At the same time the axial bearings are installed with the opportunity of free movement in the stocks of the end ring, the body is produced in the form of a ring, and a mechanical advantage of the gears and the cog-wheel is equal to 1:2.

Implementation of pistons with a support washer and axial bearings with necks having spherical surfaces and installed in the slots of the end ring with the possibility of free movement provides a sliding of the necks of axial bearings on a radial internal profile of slots of the end ring, that provides as a result a synchronous operation of subtending pistons and excludes the appearance on pistons of transverse forces leading to deterioration of pistons and cylinders, and decreases the frictional forces between the axial bearings and the end ring reducing that way the deterioration of components of the piston machine that increases the safety and durability of its work. Moreover the engagement of axial bearings of the pistons with roller-pushers located in the hubs of the gears installed in the stocks of the output shaft and interacting with the fixed cog-wheels provides a continuous sequential work of the pistons, and transmission ratio of gears and fixed cog-wheels equal to 1:2 allows within two turns of a gear to confirm a power-stroke of all pistons consecutively that increases the efficiency of the machine. The performance of the body in the form of a ring decreases radial and longitudinal dimensions of the piston machine providing its compactness.

### LIST OF DRAWINGS

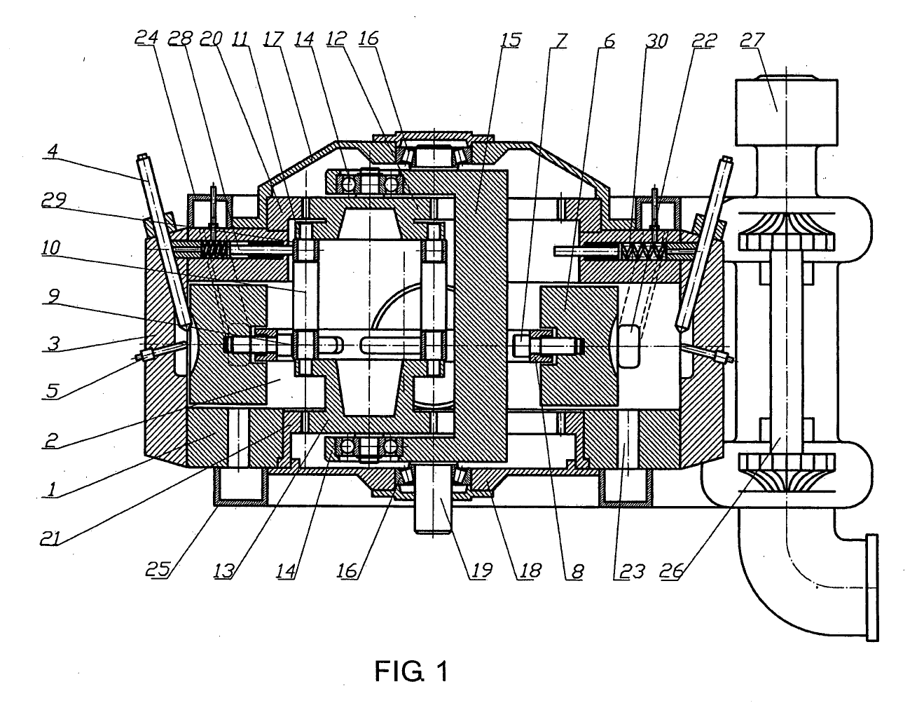

At the FIG. 1 is illustrated the piston machine in section by axles of the pistons, top view.

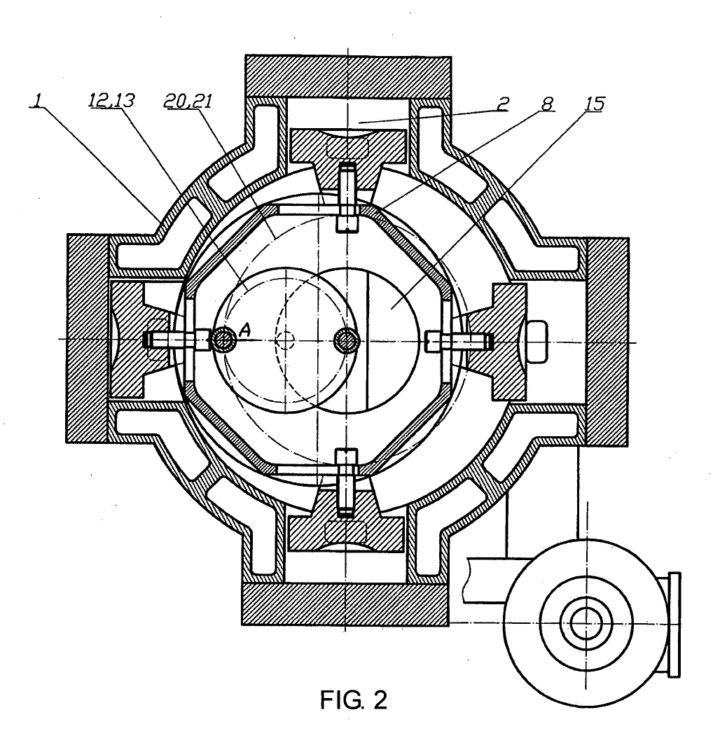

At the FIG. 2 is illustrated a cross section of the piston machine, side view.

### AN EXEMPLARY EMBODIMENT OF THE INVENTION

The piston machine includes a realized in the form of a ring body (1), in which is placed an even variety, for example, eight, of cylinders (2) lying in the same plane and situated in pairs oppositely. These cylinders (2) have fixed heads (3), in which gas-distributing mechanisms (not showed) are installed. These mechanisms include inlet and outlet valves (4, 5) connected with corresponding circular inlet and outlet collectors (6, 7).

In the cylinders (2) pistons (8) with the possibility of back-and-forth movement are installed. These pistons (8) are provided with support washers (9), made in the form of a disk spring, and axial bearings (10) on which are performed the necks (11) having the spherical surfaces (12) interacting with the radial internal profile (13) of slots of the end ring (14) installed between the support washers (9) and the axial bearings (10) located in the slots of the end ring (14) with the possibility of free movement and contacting with roller-pushers (15) installed on axles (16) in hubs (17) of two gears (18) comprising a block (19) which is installed (with the possibility of rotation on its axis (20)) on bearings (21) in stocks (22), fixed on the output shaft (23) installed on bearings (24) in the covers (25, 26) of the body (1).

On the output shaft (23) are fixed the counterbalance bushes (27) locking stocks (22) of the output shaft (23).

The gears (18) are located in the body (1) with the possibility of interacting with immovable cog-wheels (28) fixed by means of register pins (29) in the cups (30) installed in the body (1) by means of stoppers (31). The mechanical advantage of the gears (18) and the immovable cog-wheel (28) is equal to 1:2.

The suggested piston machine operates in the mode of an internal-combustion engine as follows:

Previously a fuel comes from the inlet collector (6) through an inlet valve (4) to the cylinder (2), where its combustion occurs. Under the exertion generating within the expansion of gases, the piston (8) moving along the cylinder (2) shifts the axial bearing (10) with roller-pusher (15) transferring an exertion of power-stroke to it. The roller-pusher (15) moving linearly along a trajectory passing through the center of connecting rod free piston engine affects per the axles (16) of the hub (17) the block (19) of gears (18). This block (19) rotating on bearings (21) in stocks (22) of the output shaft (23) provides a linkage of the gears (18) with fixed cog-wheels (28) and transmits the rotation to the output shaft (23). Simultaneously the piston (8) via the support washer (9) affects the end ring (14) which transfers the movement to oppositely situated piston (8) realizing the initial stage of compression stroke, the completion of which realizes the roller-pusher (15) reaching the opposite extreme location. The pistons (8) consequently via the roller-pushers (15) of the block (19) of gears (18) moving along their linear trajectories transfer the rotation to the output shaft (23), and within two turns of the output shaft (23) all four strokes of engine operation confirm.

The end ring (14) within the operation of the connecting rod free piston internal-combustion engine acts as a synchronizer of the speeds of movement of pistons (8) and roller-pushers (15), it determines a magnitude of stroke of pistons (8) equal to “2E”—two magnitudes of its eccentricity. The roller-pushers (15) each moving along its linear trajectory passing through the center of the connecting rod free piston internal-combustion engine have a stroke equal to a diameter of a pitch circle of the fixed cog-wheel (28) in consequence of what they don't have a constant contact with axial bearings (10) of pistons (8), but at the moment of touch of the axial bearings (10) with the roller-pushers (15) their linear speeds are equalized.

The piston machine operates in the pump or compressor mode as follows:

As the output shaft 23 is rotated from an electric motor (not shown in the drawing), it causes the stocks 22 and gear block 19 to rotate together therewith so that the roller-pushers 15 of the gear block 19 move radially on a linear trajectory to transmit pressure to the pistons through the axial bearings 10 thereof, which reciprocate radially on a linear trajectory as well. As the pistons 8 move forward, the material to be transferred is drawn in from the intake manifold 7 through a check valve (not shown in the drawing), and as the pistons 8 move back, the material is ejected into the outlet manifold 6, again through the check valve (not shown in the drawing).

Each revolution of the output shaft 23 causes the pistons 8 to reciprocate and consecutively draw in and push out the material to produce a continuous stream of the material being transferred.

Implementation of pistons with a support washer and axial bearings with necks having spherical surfaces and installed in slots of the end ring with the possibility of free movement provides sliding of the necks of axial bearings along the radial internal profile of the slots of the end ring, that provides a synchronous work of oppositely situated pistons and excludes the appearance on the pistons of lateral forces leading to the deteriorating of pistons and cylinders, and decreases the frictional forces between the axial bearings and the end ring, decreasing as a result the deterioration of the details of the piston machine that increases the safety and durability of its operation, in addition the contacting of axial bearings of pistons with roller-pushers located in the hubs of the gears installed in the stocks of the output shaft and interacting with fixed cog-wheels provides a continuous consecutive work of the pistons, and the transmission ratio of the gears and the fixed cog-wheels equal to 1:2 allows within two turns of the gear to fulfill a power-stroke by all pistons in series that increases the productivity of the machine. Production of the body in the form of a ring decreases radial and longitudinal dimensions of the piston machine providing its compactness.

1: A connecting rod free piston machine comprising a body with covers, installed in them output shaft interacting with the gears, and also cylinders with pistons located in pairs oppositely, wherein the pistons are provided with support washers and axial bearings produced with necks having spherical surfaces interacting with radial internal profiles of slots made in an end ring which is situated between the support washers and necks of the axial bearings contacting with roller-pushers located in the hubs of the gears installed in the stocks of an output shaft and interacting with a fixed cog-wheel.

2: A piston machine of claim 1, wherein the axial bearings of the pistons are installed in slots of the end ring with ability of free movement.

3: A piston machine of claim 1, wherein the body is made in the form of a ring.

4: A piston machine of claim 1, wherein transmission ratio of the gears and the fixed cog-wheel is equal to 1:2.
